(19) United States
(12) Patent Application Publication
(10) Pub. No.: US 2021/0172749 A1
(43) Pub. Date: Jun. 10, 2021

(54) CONTROLLING PLATOONING VEHICLE

(71) Applicant: LG ELECTRONICS INC., Seoul (KR)

(72) Inventors: Ahyoung SHIN, Seoul (KR); Minkyu PARK, Seoul (KR)

(21) Appl. No.: 16/865,783

(22) Filed: May 4, 2020

(30) Foreign Application Priority Data
Dec. 10, 2019 (KR) 10-2019-0163542

(51) Int. Cl. G01C 21/34; G01C 21/32; G05D 1/02; G08G 1/00; H04W 4/40

(52) U.S. Cl. CPC G01C 21/3469; G01C 21/32; H04W 4/40; G08G 1/22; G05D 1/0291

(57) ABSTRACT

Provided is a method of controlling a plurality of vehicles performing platooning. A method of controlling an autonomous vehicle may include destination information and vehicle information through sensors of a plurality of vehicles. A group vehicle may be determined based on the destination information. Group formation determination AI processing may be used based on fuel efficiency improvement information. An apparatus for providing passenger services according to a communication state may be associated with an artificial intelligence module, an unmanned aerial vehicle (UAV), a robot, an augmented reality (AR) device, a virtual reality (VR) device, and an apparatus related to 5G services.

This application is based on and claims priority under 35 U.S.C. 119 to Korean Patent Application No. 10-2019-0163542 filed on Dec. 10, 2019, which is incorporated herein by reference for all purposes as if fully set forth herein

### BACKGROUND OF THE INVENTION

### Field of the Invention

The present disclosure relates to a method of controlling a plurality of platooning vehicles for improving fuel efficiency and a platooning vehicle.

### Related Art

A vehicle may be classified into an internal combustion engine vehicle, an external combustion engine vehicle, a gas turbine vehicle or an electric vehicle depending on the type of motor used.

An autonomous vehicle refers to a vehicle capable of autonomously travelling without a manipulation of a driver or passenger. Automated vehicle & highway systems refer to a system for monitoring and controlling such an autonomous vehicle so that it can autonomously travel.

In the vehicle & highway systems, there is proposed a method for platooning as a method for improving fuel efficiency of vehicles and reducing a road occupation ratio.

However, the existing method has been designed as a method for minimizing fuel by designating a leader vehicle and determining a minimum distance between vehicles, an angle, etc. using communication between a plurality of vehicles. Such a method has problems in that a leader vehicle must always travel at the very front and thus fuel efficiency improvement information of vehicles within a group is not equal because the leader vehicle consumes more fuel than a plurality of other vehicles.

Furthermore, platooning is focused on only vehicles having the same destination, and may be difficult depending on a road condition or vehicle congestion.

### SUMMARY OF THE INVENTION

The present disclosure can solve the aforementioned needs and/or problems.

Furthermore, the present disclosure provides a method, which enables a plurality of vehicles to travel as a group while equally improving fuel efficiency by sharing fuel efficiency of the vehicles that travel a given distance although the vehicles have different destinations.

Furthermore, the present disclosure provides the equal improvement of fuel efficiency by controlling each of a plurality of vehicles so that a vehicle in the vanguard of a group moves to the last.

Furthermore, the present disclosure provides a method of determining a sequence by considering the amount of fuel used when a vehicle joins or leaves platooning.

Technical objects to be achieved in the present disclosure are not limited to the aforementioned technical objects, and other technical objects not described above may be evidently understood by a person having ordinary skill in the art to which the present disclosure pertains from the following description.

In an embodiment of the present disclosure, a method of controlling a plurality of vehicles performing platooning in an autonomous driving system includes generating map data in order to form a group of a plurality of vehicles, specifying a group based on the map data, obtaining fuel efficiency information of the plurality of vehicles performing the platooning, calculating fuel efficiency improvement information according to the platooning based on the fuel efficiency information, and controlling a group formation when a difference between the fuel efficiency improvement information of a first vehicle having a minimum fuel efficiency improvement and the fuel efficiency improvement information of a second vehicle having a maximum fuel efficiency improvement among the plurality of vehicles exceeds a preset critical range.

Furthermore, generating the map data may include mapping, to a map, at least one of sensing information obtained through sensors of the plurality of vehicles, destination information of the plurality of vehicles obtained through V2X messages or traffic information obtained through a server.

Furthermore, specifying a group based on the map data may include setting a placement point of the vehicle based on any one of destinations of the vehicles, density of the vehicles, the number of lanes or the fuel efficiency improvement information, setting, as a first group vehicle, a vehicle included in a preset critical section based on the placement point, determining a moving distance within the group, and determining a second group vehicle based on the moving distance.

Furthermore, the placement point may include at least any one of a source, a breakaway point of the second group vehicle or a point at which a specific vehicle joins the group. The placement point may be set based on any one of the density, the number of lanes or the fuel efficiency improvement information.

Furthermore, the fuel efficiency improvement information may be calculated based on a difference between the fuel efficiency information and actually consumed fuel of the plurality of vehicles.

Furthermore, the actually consumed fuel may be fuel consumed to travel a preset critical distance based on the map data.

Furthermore, controlling a group formation may include setting a vehicle having higher fuel efficiency improvement information as a vehicle having higher fuel efficiency ranking and moving driving ranking of the vehicle having higher fuel efficiency ranking to lower ranking within the group.

Furthermore, the group formation may be determined based on at least any one of the number of vehicles performing the platooning, type of the vehicles, destinations of the vehicles or geographical features.

Furthermore, the group formation may be determined based on AI processing results.

Furthermore, controlling a group formation may include considering, as identical fuel efficiency ranking, vehicles having identical fuel efficiency improvement information.

Furthermore, controlling a group formation may include updating the fuel efficiency improvement information within the group when a joining vehicle or a breakaway vehicle occurs.

Furthermore, controlling a group formation may include controlling at least one vehicle performing the platooning to leave the group and controlling a specific vehicle selected based on at least any one of a model or destination information of a vehicle performing the platooning to join the group.

Furthermore, the method may further include measuring an average of the fuel efficiency improvement information of a specific vehicle before the specific vehicle joins the group when the specific vehicle joins the group.

Furthermore, controlling a group formation may include detecting, as a breakaway vehicle, a vehicle whose path different from a driving path of the platooning vehicle may be set during the platooning and performing fuel efficiency calculation for all vehicles included in the group including the breakaway vehicle based on a difference between the fuel efficiency improvement information according to the platooning and fuel efficiency improvement information of the breakaway vehicle.

Furthermore, the method may further include performing fuel efficiency calculation based on a difference between a fuel efficiency improvement average value of the group calculated based on the fuel efficiency improvement information of the plurality of vehicles and a fuel efficiency improvement value of each of the plurality of vehicles when a specific vehicle leaves the group.

In according to another embodiment of the present disclosure, an apparatus for controlling a plurality of vehicles performing platooning in an autonomous driving system includes a communication unit, a memory, and a processor functionally connected to the communication unit and the memory. The communication unit receives fuel efficiency of the plurality of vehicles performing the platooning. The processor is configured to generate map data for forming a group of the plurality of vehicles, store the map data in the memory, specify a group based on the map data, obtain fuel efficiency information of each of the plurality of vehicles through the communication unit, calculate fuel efficiency improvement information according to the platooning based on the fuel efficiency information, and control a group formation when a difference between the fuel efficiency improvement information of a first vehicle having a minimum fuel efficiency improvement and the fuel efficiency improvement information of a second vehicle having a maximum fuel efficiency improvement among the plurality of vehicles exceeds a preset critical range.

The method of controlling a plurality of platooning vehicles for improving fuel efficiency and the platooning vehicle according to embodiments of the present disclosure may have the following effects.

A plurality of vehicles can improve fuel efficiency by forming a group.

Furthermore, a plurality of vehicles can share their fuel efficiency and travel as a group while equally improving fuel efficiency.

Furthermore, the present disclosure can propose a method of determining a sequence by considering the amount of fuel used when a vehicle joins or leaves platooning.

Effects which may be obtained in the present disclosure are not limited to the aforementioned effects, and other technical effects not described above may be evidently understood by a person having ordinary skill in the art to which the present disclosure pertains from the following description.

### BRIEF DESCRIPTION OF THE DRAWINGS

The accompanying drawings, which are included as part of the detailed description to help understand the present disclosure, provide an embodiment of the present disclosure and together with the description, describe the technical features of the present disclosure.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a block diagram of an AI apparatus according to an embodiment of the present disclosure.

FIG. 7 is a diagram for describing a system in which an automatic driving vehicle and an AI apparatus are linked according to an embodiment of the present disclosure.

FIG. 8 shows an example of a type of V2X application.

FIG. 9 is a block diagram illustrating communication between a vehicle and a control apparatus according to an embodiment of the present disclosure.

FIG. 10 is a flowchart illustrating an example of a method of performing, by a plurality of vehicles, platooning for improving fuel efficiency according to an embodiment of the present disclosure.

FIG. 11 is a flowchart illustrating a process of generating map data according to an embodiment of the present disclosure.

FIG. 12 is a diagram illustrating placement points and sections in map data according to an embodiment of the present disclosure.

FIG. 13 is a flowchart illustrating a process of specifying a group vehicle according to an embodiment of the present disclosure.

FIG. 14 is a diagram illustrating a specified group indicated in map data according to an embodiment of the present disclosure.

FIG. 15 is a diagram for describing an example in which a group is determined according to an embodiment of the present disclosure.

FIG. 16 is a flowchart illustrating an example of a process of transmitting and receiving, by a vehicle and the control apparatus, information according to an embodiment of the present disclosure.

FIG. 17 is a diagram for specifically describing a flow of data between elements according to an embodiment of the present disclosure.

FIG. 18 is a diagram illustrating control of a group formation according to an embodiment of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the disclosure, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

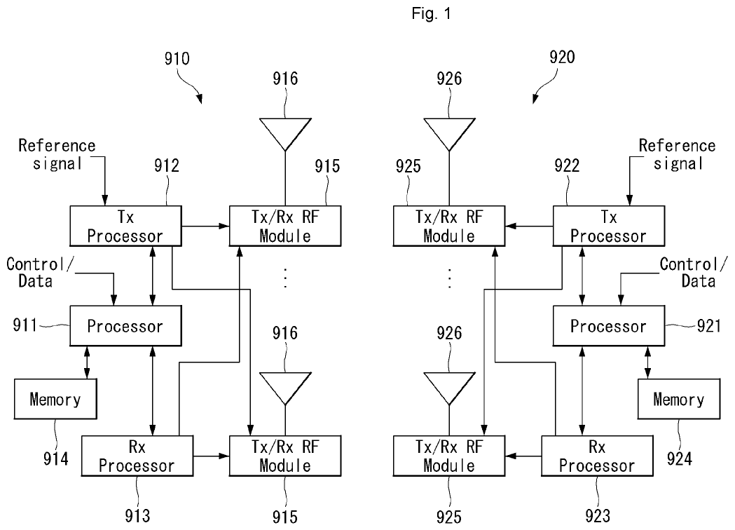

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

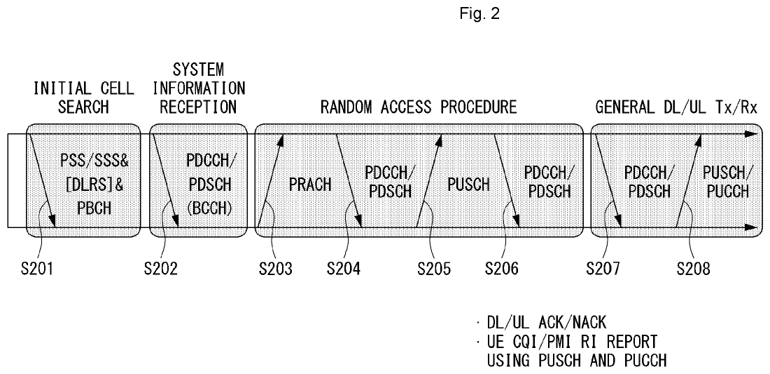

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (System InformationBlock1) and is transmitted by a BS through a PBCH of an SSB. SIB1 includes information related to availability and scheduling (e.g., transmission periodicity and SI-window size) of the remaining SIBs (hereinafter, SIBx, xis an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionlnDCl by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

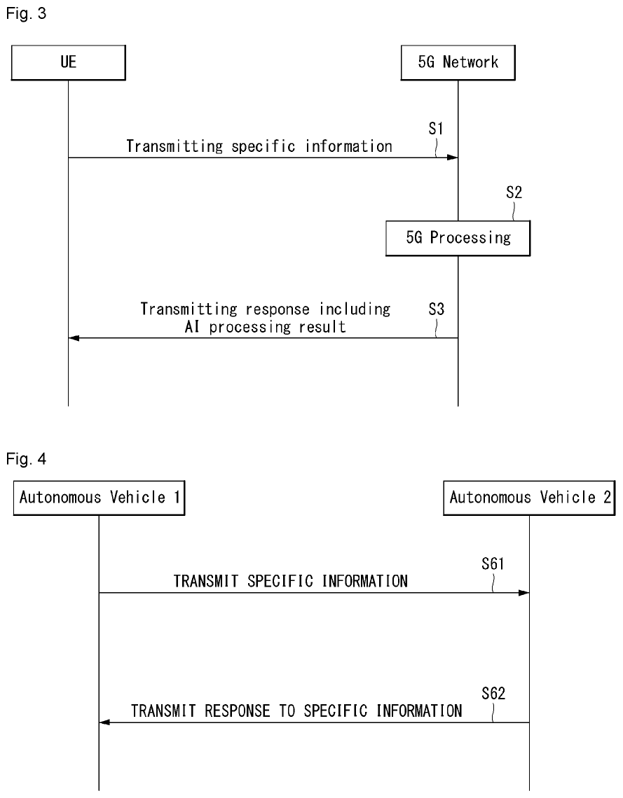

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

A configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5 A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

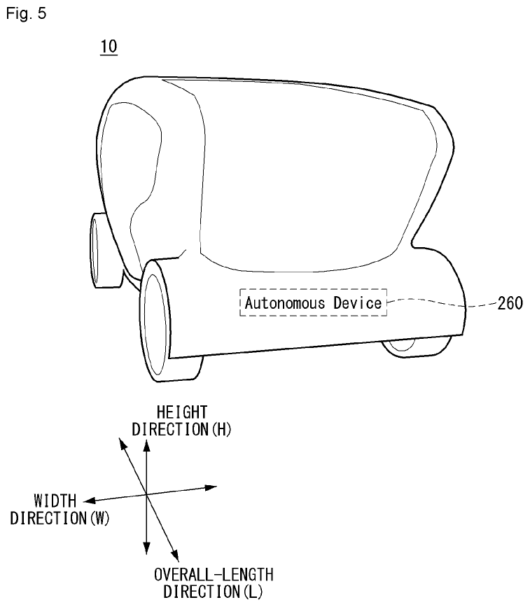

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

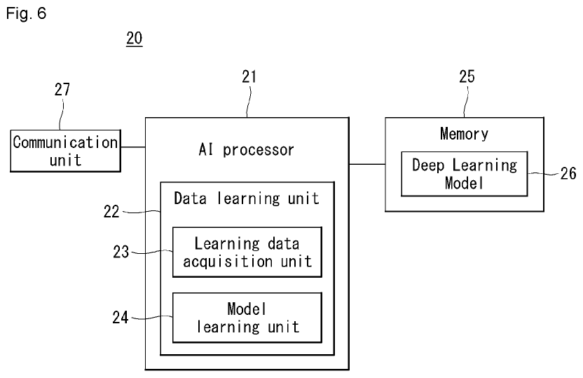

FIG. 6 is a block diagram of an AI apparatus according to an embodiment of the present disclosure.

Referring to FIG. 6, an AI apparatus 20 may include an electronic device including an AI module which may perform an AI processing or a server including the AI module. In addition, the AI apparatus 20 may be included as at least an element of the vehicle 10 shown in FIG. 5 and provided to perform at least a part of AI processing.

The AI processing may include all operations related to driving of the vehicle 10 shown in FIG. 5. For example, the automatic driving vehicle may perform AI processing of sensing data or driver data and perform operations of processing/determination and generating a control signal. Furthermore, for example, the automatic driving vehicle may perform an automatic driving control by performing AI processing of data obtained through an interaction with another electronic device provided in the vehicle.

The AI apparatus 20 may include an AI processor 21, a memory 25 and/or a communication unit 27.

The AI apparatus 20 may be a computing apparatus which may perform a neural network learning and implemented with various electronic devices such as a server, a desktop, a PC, a notebook PC, a tablet PC.

The AI processor 21 may perform a neural network learning using the program stored in the memory 25. Particularly, the AI processor 21 may perform a neural network learning for recognizing vehicle related data. Here, the neural network for recognizing the vehicle related data may be designed to simulate a brain structure of a human on a computer and may include a plurality of network nodes having a priority which simulating a neuron of human neural network. A plurality of network nodes may exchange data according to each connection relation to simulate a synaptic activity of the neuron, which the neuron exchanges a signal through a synapse. Here, the neural network may include a deep learning model which is developed from the neural network model. In the deep learning model, a plurality of network nodes may exchange data according to a convolution connection relation with being located in different layers. An example of the neural network model may include various deep learning techniques such as deep neural networks (DNN), convolutional deep neural networks (CNN), Recurrent Boltzmann Machine (RNN), Restricted Boltzmann Machine (RBM), deep belief networks (DBN), Deep Q-Network, and may be applied to a field such as computer vision, voice recognition, natural language process and voice/signal processing.

The processer that performs the functions described above may be a general-purpose processor (e.g., CPU) but an AI-dedicated processor (e.g., GPU) for an artificial intelligence learning.

The memory 25 may store various types of program and data required for an operation of the AI apparatus 20. The memory 25 may be implemented with non-volatile memory, volatile memory, flash memory, hard disk drive (HDD) or solid-state drive (SDD). The memory 25 may be accessed by the AI processor 21 and read/record/modification/deletion/update of data may be performed by the AI processor 21. In addition, the memory 25 may store a neurotic network model (e.g., deep learning model 26) which is generated through a learning algorithm for data classification/recognition according to an embodiment of the present disclosure.

The AI processor 21 may include a data learning unit 22 that learns a neurotic network for the classification/recognition. The data learning unit 22 may learn a criterion on which learning data is used to determine the classification/recognition and how to classify and recognize data using the learning data. The data learning unit 22 may obtain learning data used for learning and apply the obtained learning data to the deep learning model, and accordingly, learn the deep learning model.

The data learning unit 22 may be manufactured in at least one hardware chip shape and mounted on the AI apparatus 20. For example, the data learning unit 22 may be manufactured in hardware chip shape dedicated for the artificial intelligence (AI) or manufactured as a part of a general-purpose processor (CPU) or a graphic processing processor (GPU) and mounted on the AI apparatus 20. Furthermore, the data learning unit 22 may be implemented with a software module. In the case that the data learning unit 22 is implemented with a software module (or program module including instruction), the software module may be stored in a non-transitory computer readable media. In this case, at least one software module may be provided by an Operating System (OS) or an application.

The data learning unit 22 may include a learning data acquisition unit 23 and a model learning unit 24.

The learning data acquisition unit 23 may acquire learning data which is required for the neurotic network model for classifying and recognizing data. For example, the learning data acquisition unit 23 may obtain vehicle data and/or sample data for being inputted in the neurotic network model as learning data.

The model learning unit 24 may learn to have a determination criterion how to classify predetermined data by the neurotic network model using the obtained learning data. In this case, the model learning unit 24 may learn the neurotic network model through a supervised learning that uses at least one determination criterion among learning data. Alternatively, the model learning unit 24 may learn the learning data without supervising and learn the neurotic network model through an unsupervised learning which discovers a determination criterion. In addition, the model learning unit 24 may learn the neurotic network model through a reinforcement learning using a feedback whether a result of an assessment of situation according to learning is correct. Furthermore, the model learning unit 24 may learn the neurotic network model using a learning algorithm including an error back-propagation or a gradient decent.

When the neurotic network model is learned, the model learning unit 24 may store the learned neurotic network model in a memory. The model learning unit 24 may store learned neurotic network model in the memory of a server connected to the AI apparatus 20 in wired or wireless manner.

The data learning unit 22 may further include a learning data pre-processing unit (not shown) or a learning data selection unit (not shown) for improving an analysis result of the learning model or saving a resource or time which is required for generating a recognition model.

The learning data pre-processing unit may pre-process obtained data such that the obtained data is used for learning for an assessment of situation. For example, the learning data pre-processing unit may process the obtained data in a preconfigured format such that the model learning unit 24 uses the learning data obtained for learning an image recognition.

In addition, the learning data selection unit may select the data required for learning between the learning data obtained in the learning data acquisition unit 23 or the learning data pre-processed in the pre-processing unit. The selected learning data may be provided to the model learning unit 24. For example, the learning data selection unit may detect a specific area in the image obtained through the camera and select only the data for the object included in the specific area as the learning data.

Furthermore, the data learning unit 22 may further include a model evaluation unit (not shown) for improving the analysis result of the learning model.

The model evaluation unit may input evaluation data in the neurotic network model, and in the case that the analysis result fails to satisfy a predetermined level, make the data learning unit 22 learn the neurotic network model again. In this case, the evaluation data may be predefined data for evaluating a recognition model. As an example, in the case that the number of evaluation data or the ratio in which the analysis result is not clear exceeds a preconfigured threshold value in the analysis result of the recognition model which is learned for the evaluation data, the model evaluation unit may evaluate that the analysis result fails to satisfy the predetermined level.

The communication unit 27 may the AI processing result by the AI processor 21 to an external electronic device.

Here, the external electronic device may be defined as an automatic driving vehicle. In addition, the AI apparatus 20 may be defined as another vehicle or 5G network that communicates with the automatic driving vehicle or an automatic driving module mounted vehicle. The AI apparatus 20 may be implemented with being functionally embedded in the automatic driving module provided in a vehicle. In addition, 5G network may include a server or module that performs a control in relation to an automatic driving.

The AI apparatus 20 shown in FIG. 6 is described by functionally dividing into the AI processor 21, the memory 25 and the communication unit 27, but the elements described above may be integrated in a module and called an AI module.

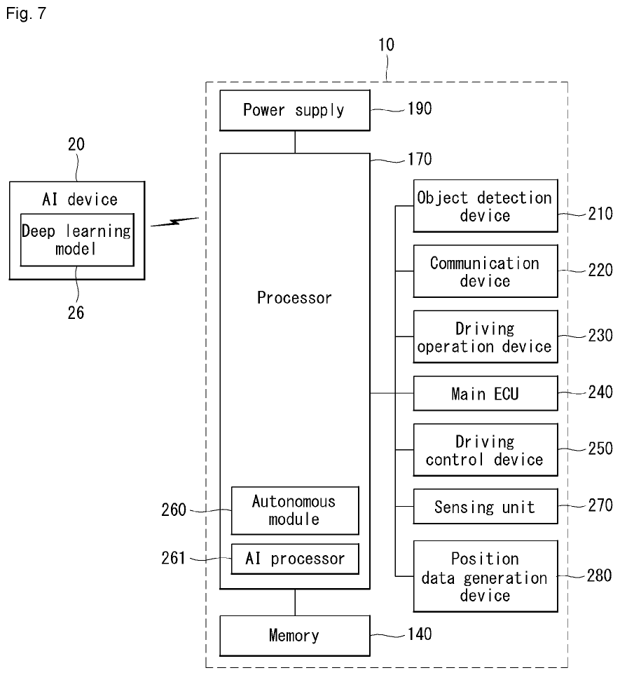

FIG. 7 is a diagram for describing a system in which an automatic driving vehicle and an AI apparatus are linked according to an embodiment of the present disclosure.

Referring to FIG. 7, the automatic driving vehicle 10 may transmit data required for AI processing to the AI apparatus 20 through a communication unit, and the AI apparatus 20 including the deep learning model 26 may transmit the AI processing result using the deep learning model 26 to the automatic driving vehicle 10. The AI apparatus 20 may be referred to the content described in FIG. 6.

The automatic driving vehicle 10 may include a memory 140, a processor 170 and a power supply unit 190, and the processor 170 may further include an automatic driving module 260 and an AI processor 261. In addition, the automatic driving vehicle 10 may be connected to at least one electronic device provided in the vehicle in wired or wireless manner and may include an interface unit that may exchange data required for an automatic driving control. The at least one electronic device connected through the interface unit may include an object detection unit 210, a communication unit 220, a driving manipulation unit 230, a main ECU 240, a vehicle driving unit 250, a sensing unit 270 and a position data generation unit 280.

The interface unit may include at least one of a communication module, a terminal, a pin, a cable, a port, a circuit, a device and an apparatus.

The memory 140 is electrically connected to the processor 170. The memory 140 may store basic data for a unit, control data for operation control of a unit and input/output data. The memory 140 may store data processed in the processor 170. The memory 140 may include at least one of ROM, RAM, EPROM, flash memory, hard drive in hardware. The memory 140 may store various data for general operation of the automatic driving vehicle 10 such as a program for processing or control of the processor 170. The memory 140 may be integrally implemented with the processor 170. According to an embodiment, the memory 140 may be classified as a lower layer component of the processor 170.

The power supply unit 190 may supply power to the automatic driving vehicle 10. The power supply unit 190 may receive power from a power source (e.g., battery) included in the automatic driving vehicle 10 and supply the power to each unit of the automatic driving vehicle 10. The power supply unit 190 may be operated according to a control signal provided from the main ECU 240. The power supply unit 190 may include a switched-mode power supply (SMPS).

The processor 170 may be electrically connected to the memory 140, the interface unit 280 and the power supply unit 190 and exchange a signal. The processor 170 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and an electric unit for performing other functions.

The processor 170 may be driven by the power supplied from the power supply unit 190. The processor 170 may receive data, process data, generate a signal and provide a signal in the state that power is supplied by the power supply unit 190.

The processor 170 may receive information from another electronic device in the automatic driving unit 10 through the interface unit. The processor 170 may provide a control signal to another electronic device in the automatic driving unit 10 through the interface unit.

The automatic driving unit 10 may include at least one printed circuit board (PCB). The memory 140, the interface unit, the power supply unit 190 and the processor 170 may be electrically connected on the printed circuit board.

Hereinafter, the other electronic device in a vehicle connected to the interface unit, the AI processor 261 and the automatic driving module 260 are described in more detail. Hereinafter, for the convenience of description, the automatic driving unit 10 is called a vehicle 10.

First, the object detection unit 210 may generate information for an object outside of the vehicle 10. The AI processor 261 may apply the neurotic network model to the data obtained through the object detection unit 210 and generate at least one of a presence of an object, position information of an object, distance information between a vehicle and an object and relative velocity information between a vehicle and an object.

The object detection unit 210 may include at least one sensor that may detect an object outside of the vehicle 10. For example, the sensor may include a camera, a radar, a LIDAR, an ultrasonic sensor and an infrared sensor. The object detection unit 210 may provide the data for an object generated based on a sensing signal generated in the sensor to at least one electronic device included in the vehicle.

The vehicle 10 may transmit the data obtained through the at least one sensor to the AI apparatus 20 through the communication unit 220, and the AI apparatus 20 may apply the neurotic network model 26 to the forwarded data and transmit the generated AI processing data to the vehicle 10. The vehicle 10 may recognize the information for the detected object based on the received AI processing data, and the automatic driving module 260 may perform an automatic driving control operation using the recognized information.

The communication unit 220 may exchange a signal with a device located outside of the vehicle 10. The communication unit 220 may exchange a signal with at least one of an infra (e.g., server, broadcasting station), another vehicle and a terminal. The communication unit 220 may include at least one of a transmission antenna, a reception antenna, a Radio Frequency (RF) circuit in which various communication protocols may be implemented and an RF device to perform a communication.

The neurotic network model is applied to the data obtained through the object detection unit 210, and at least one of a presence of an object, position information of an object, distance information between a vehicle and an object and relative velocity information between a vehicle and an object may be generated.

The driving manipulation unit 230 is a device for receiving a user input for driving. In a manual mode, the vehicle 10 may be driven based on a signal provided by the driving manipulation unit 230. The driving manipulation unit 230 may include a steering input device (e.g., steering wheel), an acceleration input device (e.g. acceleration pedal) and a brake input device (e.g., brake pedal).

The AI processor 261 may generate an input signal of the driving manipulation unit 230 according to a signal for controlling a motion of the vehicle according to a driving plan which is generated through the automatic driving module 260.

The vehicle 10 may transmit data required for controlling the driving manipulation unit 230 to the AI apparatus 20, and the AI apparatus 20 may apply the neurotic network model to the forwarded data and transmit the generated AI processing data to the vehicle 10. The vehicle 10 may use the input signal of the driving manipulation unit 230 in the motion control of the vehicle based on the received AI processing data.

The main ECU 240 may control the overall operation of the at least one electronic device provided in the vehicle 10.

The vehicle driving unit 250 is a device that electrically control various vehicle driving devices in the vehicle 10. The vehicle driving unit 250 may include a power train driving control device, a chassis driving control device, a door/window driving control device, a safety device driving control device, a lamp driving control device and an air conditioning driving control device. The power train driving control device may include a power source driving control device and a transmission driving control device. The chassis driving control device may include a steering driving control device, a brake driving control device and a suspension driving control device. The safety device driving control device may include a safety belt driving control device for safety belt control.

The vehicle driving unit 250 includes at least one electronic control device (e.g., control Electronic Control Unit (ECU)).

The vehicle driving unit 250 may control the power train, the steering device and the brake device based on the signal received from the automatic driving module 260. The signal received from the automatic driving module 260 may be a driving control signal which is generated by applying the neurotic network model to vehicle related data. The driving control signal may be a signal received from the external AI apparatus 20 through the communication unit 220.

The sensing unit 270 may sense a state of the vehicle. The sensing unit 270 may include at least one of an inertial measurement unit (IMU) sensor, a collision sensor, a wheel sensor, a speed sensor, an inclination sensor, a weight detection sensor, a heading sensor, a position module, a vehicle forward or reverse driving sensor, a battery sensor, a fuel sensor, a tire sensor, a steering sensor, a temperature sensor, a humidity sensor, an ultrasonic sensor, an illuminance sensor and a pedal position sensor. The inertial measurement unit (IMU) sensor may include at least one of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

The AI processor 261 may apply the neurotic network model to the sensing data generated by at least one sensor and generate state data of the vehicle. The AI processing data generated by applying the neurotic network model may include vehicle positioning data, vehicle motion data, vehicle yaw data, vehicle roll data, vehicle pitch data, vehicle collision data, vehicle direction data, vehicle angle data, vehicle velocity data, vehicle acceleration data, vehicle inclination data, vehicle forward/reverse driving data, vehicle weight data, battery data, fuel data, tire air pressure data, vehicle internal temperature data, vehicle internal humidity data, steering wheel rotation angle data, vehicle external illuminance data, pressure data exerted on an acceleration pedal, pressure data exerted on a brake pedal, and the like.

The automatic driving module 260 may generate a driving control signal based on the state data of the vehicle which is AI-processed.

The vehicle may transmit the sensing data obtained through the at least one sensor to the AI apparatus 20, and the AI apparatus 20 may apply the neurotic network model to the forwarded sensing data and transmit the generated AI processing data to the vehicle 20.

The position data generation unit 280 may generate position data of the vehicle 10. The position data generation unit 280 may include at least one of Global Positioning System (GPS) and Differential Global Positioning System (DGPS).

The AI processor 261 may apply the neurotic network model to the position data generated by the at least one position data generation device and generate more accurate position data of the vehicle.

According to an embodiment, the AI processor 261 may perform the deep learning operation based on at least one of the Inertial Measurement Unit (IMU) of the sensing unit 270 and the camera image of the object detection unit 210 and correct the position data based on the generated AI processing data.

The vehicle 10 may transmit the position data obtained by the position data generation unit 280 to the AI apparatus 20, and the AI apparatus 20 may apply the neurotic network model 26 to the received position data, and accordingly, transmit the generated AI processing data to the vehicle 20.

The vehicle 10 may include an internal communication system 50. A plurality of electronic devices included in the vehicle 10 may exchange a signal by a medium of the internal communication system 50. The signal may include data. The internal communication system 50 may use at least one communication protocol (e.g., CAN, LIN, FlexRay, MOST and ethernet).

The automatic driving module 260 may generate a driving plan for generating a path for the automatic driving and driving the vehicle following the generated path based on the obtained data.

The automatic driving module 260 may implement at least one Advanced Driver Assistance System (ADAS) function. The ADAS may implement at least one of Adaptive Cruise Control (ACC), Autonomous Emergency Braking (AEB), Forward Collision Warning (FCW), Lane Keeping Assist (LKA), Lane Change Assist (LCA), Target Following Assist (TFA), Blind Spot Detection (BSD), High Beam Assist (HBA), Auto Parking System (APS), PD collision warning system, Traffic Sign Recognition (TSR), Traffic Sign Assist (TSA), Night Vision (NV), Driver Status Monitoring (DSM) and Traffic Jam Assist (TJA).

The AI processor 261 may apply information received from at least one sensor provided in the vehicle, traffic related information received from an external device and information received from another vehicle that communicates with the vehicle to the neurotic network model and a control signal which may perform at least one ADAS functions described above to the automatic driving module 260.

In addition, the vehicle may transmit at least one data for performing the ADAS functions to the AI apparatus 20 through the communication unit 220, and the AI apparatus 20 may apply the neurotic network model to the received data, and accordingly, the control signal which may perform the ADAS function to the vehicle 10.

The automatic driving module 260 may obtain state information of a driver and/or state information of the vehicle through the AI processor 261, and based on it, may perform the switching operation from the automatic driving mode to the manual driving mode or the switching operation from the manual driving mode to the automatic driving mode.

The vehicle 10 may use the AI processing data for a passenger support to a driving control. For example, as described above, through at least one sensor provided in the vehicle, states of a driver or a passenger may be identified.

Alternatively, the vehicle 10 may recognize a voice signal of a driver or a passenger through the AI processor 261, perform a voice processing operation and perform a voice composition operation.

The above-described 5G communication technology may apply in conjunction with methods proposed in the present invention, or may be supplemented to further specify or clarify technical feature of the methods proposed in the present invention.

Hereinafter, according to an embodiment of the present specification, a detailed method of saving each vehicle's equivalent fuel efficiency improvement through the platooning driving vehicle control method will be described with reference to drawings.

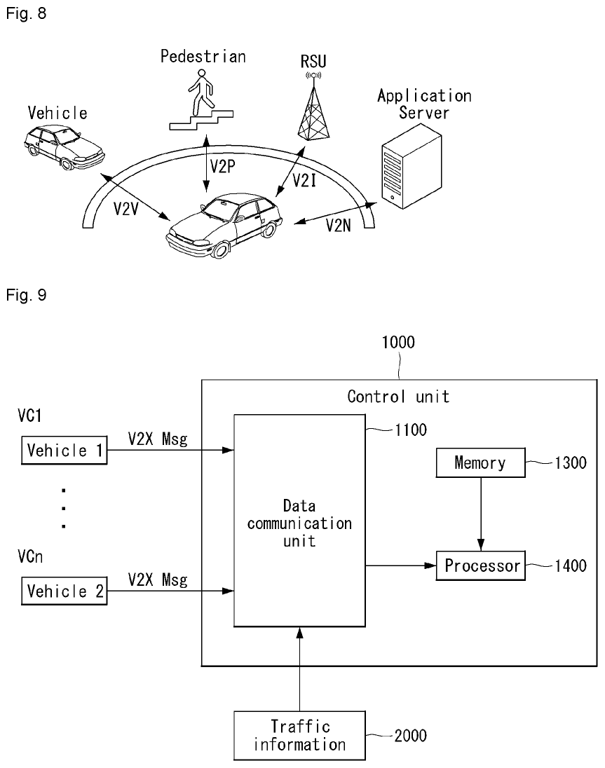

FIG. 8 illustrates V2X communication to which the present disclosure is applicable.

V2X communication includes communication between a vehicle and any entity, such as V2V (Vehicle-to-Vehicle) referring to communication between vehicles, V2I (Vehicle to Infrastructure) referring to communication between a vehicle and an eNB or a road side unit (RSU), V2P (Vehicle-to-Pedestrian) referring to communication between a vehicle and a UE carried by a person (a pedestrian, a bicycle driver, or a vehicle driver or passenger), and V2N (vehicle-to-network).

V2X communication may refer to the same meaning as V2X sidelink or NR V2X or refer to a wider meaning including V2X sidelink or NR V2X.

V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

V2X communication can be provided through a PC5 interface and/or a Uu interface. In this case, specific network entities for supporting communication between vehicles and every entity can be present in wireless communication systems supporting V2X communication. For example, the network entities may be a BS (eNB), a road side unit (RSU), a UE, an application server (e.g., traffic safety server) and the like.

Further, a UE which performs V2X communication may refer to a vehicle UE (V-UE), a pedestrian UE, a BS type (eNB type) RSU, a UE type RSU and a robot including a communication module as well as a handheld UE.

V2X communication can be directly performed between UEs or performed through the network entities. V2X operation modes can be categorized according to V2X communication execution methods.

V2X communication is required to support pseudonymity and privacy of UEs when a V2X application is used such that an operator or a third party cannot track a UE identifier within an area in which V2X is supported.

The terms frequently used in V2X communication are defined as follows.
RSU (Road Side Unit): RSU is a V2X service enabled device which can perform transmission/reception to/from moving vehicles using a V2I service. In addition, the RSU is a fixed infrastructure entity supporting a V2X application and can exchange messages with other entities supporting the V2X application. The RSU is a term frequently used in conventional ITS disclosures and is introduced to 3GPP disclosures in order to allow documents to be able to be read more easily in ITS industry. The RSU is a logical entity which combines V2X application logic with the function of a BS (BS-type RSU) or a UE (UE-type RSU).
V2I service: A type of V2X service having a vehicle as one side and an entity belonging to infrastructures as the other side.
V2P service: A type of V2X service having a vehicle as one side and a device carried by a person (e.g., a pedestrian, a bicycle rider, a driver or a handheld UE device carried by a fellow passenger) as the other side.
V2X service: A 3GPP communication service type related to a device performing transmission/reception to/from a vehicle.
V2X enabled UE: UE supporting V2X service.
V2V service: A V2X service type having vehicles as both sides.
V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V2P) as described above.

FIG. 9 is a block diagram illustrating a control system between a vehicle and a server, which may be applied to an embodiment of the present disclosure.

In an autonomous driving system, platooning means that a plurality of vehicles travels on a road in a group form under the same control.

In an embodiment of the present disclosure an autonomous driving control apparatus 1000 may include a data communication unit 1100, a processor 1400, and a memory 1300. The data communication unit 1100 is connected to the vehicles, two or more autonomous vehicles VC1 . . . VCn under the same control, and may transmit and receive data. To this end, the data communication unit 1100 may be connected to the vehicles via a base station. Specifically, the data communication unit 1100 may provide a communication interface necessary to provide a transmission or reception signal between a mobile terminal, including a vehicle, and a server in a data packet form while operating in conjunction with a network (e.g., 3G, 4G, LTE or 5G network). Furthermore, the data communication unit 1100 may support a variety of types of Internet of things (IoT), Internet of everything (IoE), and Internet of small things (IoST), and may support machine to machine (M2M) communication, vehicle to everything communication (V2X) communication, and device to device (D2D) communication, but the present disclosure is not limited thereto.

Each of the two or more autonomous vehicles VC1 . . . VCn is a vehicle that travels without a user's manipulation or a user's minimum manipulation as described above. Hereinafter, an “autonomous vehicle” is referred to as a “vehicle”, for convenience of description.

Hereinafter, the function of each element is described in detail.

The autonomous driving control apparatus 1000 may use or include the elements illustrated in FIGS. 5 and 7. For example, the data communication unit 1100 may correspond to at least some of the communication unit 220 of the vehicle 10. Furthermore, the processor 1400 may correspond to the vehicle driving unit 250.

The autonomous driving control apparatus 1000 may obtain information on the destination of each of the plurality of vehicles VC1 . . . VCn or information for platooning, such as a model or fuel efficiency of each of the vehicle through communication with the vehicles VC1 . . . VCn, and may control the state of each of the vehicles VC1 . . . VCn for platooning.

The data communication unit 1100 receives information from the vehicles and another vehicle, a pedestrian, or a thing in which infrastructure has been constructed over a 5G network, as described based FIG. 7. The data communication unit 1100 receives V2X messages from adjacent vehicles. The V2X message includes “driving history information” and “steering information” of the vehicles. Furthermore, the data communication unit 1100 receives V2I messages from traffic information 2000.

The processor 1400 may include one or more of a central processing unit, an application processor or a communication processor. The processor 1400 may execute an operation or data processing related to control and/or communication of at least one different element of the autonomous driving control apparatus 1000, and may execute instructions related to the execution of a computer program.

The processor 1400 may control a group formation based on AI processing results obtained by applying, to an AI model, driving information obtained from each of the plurality of vehicles VC1 . . . VCn that form a group.

The processor 1400 configures a group formation based on map data stored in the memory 1300. The processor 1400 sets the placement point of a vehicle based on the destinations of vehicles, the density of the vehicles, the number of lanes or fuel efficiency improvement information of the vehicles. If a placement point is set, the processor 1400 searches for primary group vehicle candidates that travel in the same driving path across a given distance based on V2X messages received from the data communication unit 1100. Furthermore, the processor 1400 selects a secondary group vehicle among the primary group vehicle candidates.

The memory 1300 may be a volatile and/or non-volatile memory, and stores instructions or data related to at least one different element of the processor 1400. Particularly, the memory 1300 may store a computer program for controlling the platooning of a vehicle or instructions or data related to a recording medium.

Hereinafter, an embodiment in which fuel efficiency improvement information of a plurality of vehicles that try to perform platooning and embodiments in which a formation of platooning is determined based on fuel efficiency improvement information are described more specifically with reference to the following drawings.

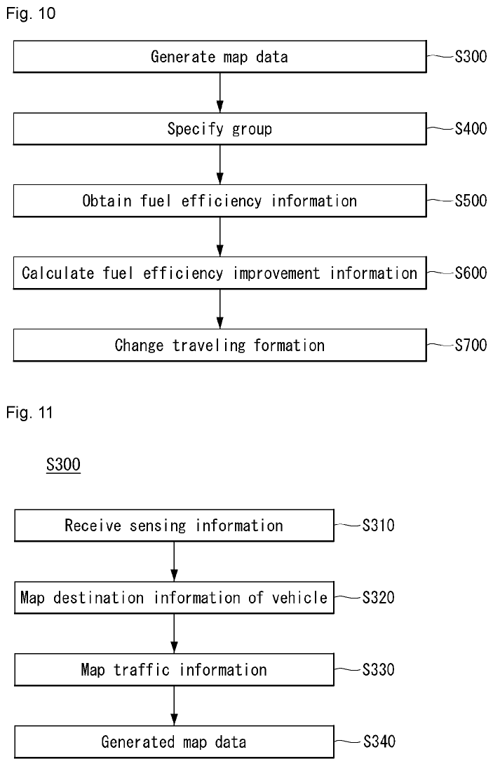

FIG. 10 is a flowchart illustrating an example of a method of performing, by a plurality of vehicles, platooning for improving fuel efficiency according to an embodiment of the present disclosure. The method for performing platooning may be implemented by the autonomous driving control apparatus 1000 for controlling platooning. The method may be implemented by the processor 1400 of the autonomous driving control apparatus 1000. The autonomous driving control apparatus 1000 may be a server for controlling vehicles that perform platooning.

Referring to FIG. 10, the processor 1400 may generate map data based on information obtained through the data communication unit 1100 (S300).

The processor 1400 may obtain at least one piece of information for generating the map data through the data communication unit 1100. The map data may mean a map in which information on a road driving space of a vehicle and information on each of a plurality of vehicles have been visually represented.

Particularly, a “detailed map” a “high definition (HD) map” or a “highly automated driving (HAD) map” containing more detailed information rather than a simple navigation map may be applied to a digital map for autonomous driving.

The detailed map may include traffic information. In this case, if a vehicle receives traffic information through a smartphone navigation, there is a problem in that traffic information cannot be controlled because it is changed by a passenger's choice.

According to an embodiment of the present disclosure, an unnecessary lane change of each of vehicles that perform platooning may be limited by configuring a path in which traffic information has been incorporated into the detailed map. In this case, a plurality of vehicles can find a fast and accurate road, and this may be useful for fuel efficiency.

A process of generating map data is described below.

Road environment information that may be understood by a computer may be previously stored in a database form. The map data may include lane information necessary for the execution of autonomous driving and three-dimensional road environment information necessary for an autonomous driving system, such as a guardrail, road curvature, a slope, and a traffic mark.

Furthermore, the map data may generate by indicating, in the detailed map, at least one of destinations, density, the number of lanes or fuel efficiency improvement information received from a plurality of vehicles.

The processor 1400 may specify a group based on the information obtained through V2X messages received from the plurality of vehicles (S400).

According to an embodiment of the present disclosure, destination information of each of a plurality of vehicles may be obtained through V2X messages received from the vehicles.

Specifically, vehicles that participate in a first group share their locations and destination information with other vehicles of the first group by exchanging their GPS coordinate data with other vehicle using vehicle-to-vehicle (V2V) communications (“V2V unicast” communications), and/or vehicle-2vehicles (V2X) communications (“V2V multicast” communications) and/or other available proper communications.

A placement point may be set at each of distances divided into three equal parts based on the driving path of a vehicle that has traveled the longest distance among a plurality of vehicles, based on the obtained destination information. Furthermore, the placement point may include a start point received from the V2X messages of the plurality of vehicles. The placement point may include at least one of the breakaway point of the group vehicle or specific vehicle joining into the group.

A vehicle included in a preset critical section based on the placement points of a plurality of vehicles indicated in the map data may be set as a first group vehicle.

The preset critical section may mean that it is determined based on any one of the density of vehicles, the number of lanes or the number of vehicles indicated in the map data.

Specifically, the preset critical section may be set based on any one of the density of vehicles, the number of lanes or improved information.

At least one preset critical section in which the density of vehicles is low or the number of lanes is many may be selected as the preset critical section so that the vehicles can be easily placed based on traffic information obtained through the data communication unit 1100.

According to an embodiment of the present disclosure, if the number of vehicles is fixed to 4 and the density of vehicles is low or the number of lanes is small, a critical section may be set long because the distance between a plurality of vehicles is long.

Furthermore, if the density of vehicles is high or the number of lanes is many although the number of vehicles is fixed to 4, a critical section may be set shortly because the distance between a plurality of vehicles is close.

A vehicle included in the preset critical section may be set as a first group vehicle. Destination information may be received from each of a plurality of the first group vehicles through a V2X message.

The moving distance of a second group may be configured with vehicles whose moving distance is ⅓ or more based on a vehicle having the longest destination among at least first group vehicle.

The autonomous driving control apparatus 1000 may obtain fuel efficiency information from each of the plurality of vehicles through the data communication unit 1100 (S500).

Referring to FIG. 10, the data communication unit 1100 includes a data collection and communication module, and may transmit and receive data to and from a logic-applied device, such as a controller or processor that communicates with one or more devices or systems.

The data communication unit 1100 may calculate fuel efficiency improvement information of each of the vehicles based on the fuel efficiency information of the second group vehicles (S600).

The fuel efficiency improvement information may be calculated based on a difference between the fuel efficiency information and actually consumed fuel of the plurality of vehicles.

The actually consumed fuel may mean fuel consumed to travel a preset critical distance based on the map data.

According to an embodiment of the present disclosure, the preset critical distance may be set by dividing a distance from a source to a destination at given intervals based on a vehicle that travels to the longest destination among the second group vehicles.

Furthermore, the preset critical distance may be set based on a fuel efficiency improvement amount consumed for the travelling of the second group vehicle. If a given amount is set and a specific vehicle of vehicles that perform platooning satisfies the amount, the moving distance of the specific vehicle may be set as a preset critical distance.

Fuel consumed to travel the preset critical distance means actually consumed fuel.

If the difference between pieces of the fuel efficiency improvement information exceeds a preset critical range between a first vehicle having a minimum fuel efficiency improvement and a second vehicle having a maximum fuel efficiency improvement among the plurality of vehicles, a formation capable of improving fuel efficiency may be found and changed (S700).

The processor 1400 may extract a feature value from sensing information obtained through at least one sensor in order to determine a formation of the group.

For example, the processor 1400 may receive destination information of a vehicle from at least one sensor (e.g., vision sensor). The processor 1400 may extract a feature value from the destination information of the vehicle. The feature value may specifically indicate a group formation based on any one of the destination information of the vehicle or average fuel efficiency improvement information of the group vehicle among at least one feature which may be extracted among the sensing information of the group vehicle.

The processor 1400 may calculate a difference between pieces of the fuel efficiency improvement information between a first vehicle having a minimum fuel efficiency improvement and a second vehicle having a maximum fuel efficiency improvement among the plurality of vehicles.

If a difference between the pieces of fuel efficiency improvement information of the first vehicle and the second vehicle exceeds a preset critical range, a difference between the pieces of fuel efficiency improvement information may be narrowed by controlling a group formation.

As a difference between the pieces of fuel efficiency improvement information of the first vehicle and the second vehicle is smaller, vehicles that perform platooning can equally improve fuel efficiency.

The processor 1400 may generate a group determination input by combining the extracted feature values. The group determination input may be input to an artificial neural network (ANN) classifier trained to select a group formation based on average fuel efficiency improvement information of a group vehicle based on the extracted feature values.

The processor 1400 may analyze an output value of the artificial neural network, and may determine a formation of the group based on the artificial neural network output value.

The processor 1400 may identify whether to change or maintain a group formation based on the output of the artificial neural network classifier.

The aforementioned 5G communication technology may be combined with methods proposed in the present disclosure and applied or may be supplemented to materialize or clarify the technical features of methods proposed in the present disclosure.

FIG. 11 is a flowchart illustrating a process of generating map data according to an embodiment of the present disclosure.

Specifically, in order to perform autonomous driving, three-dimensional road environment information, which is necessary for an autonomous driving system, such as lane information, a guardrail, road curvature, a slope, and a traffic mark, and which may be understood by a computer, may be obtained through sensing information received from the sensing unit 270 of the vehicle 10, and may be mapped to a detailed map (S310).

In this process, a vehicle may use a variety of types of environment recognition sensors (e.g., a camera, a radar or a lidar).

A path into which traffic information has been incorporated may be set in the detailed map to which the sensing information has been mapped (S320).

The detailed map is a kind of local dynamic map (LDM), and means a “repository that stores static/dynamic information” collected from a vehicle and infrastructure.

The LDM is a conceptual data repository including geographic information, location information, and state information within a service area in a driving path, may store traffic information such as a traffic sign, and may store and provide data, such as dynamic data or the data of a vehicle or a pedestrian.

The LDM may modify and use MAP information of a traffic information provider or sensor/application based on the ISO standard, and may use cooperative-ITS (C-ITS) and ADAS technologies for detailed electronic map development for positioning and location tracking based on a map matching algorithm.

Destination information received from each of a plurality of vehicles is mapped to the detailed map to which the traffic information has been mapped (S330).

The obtained sensing information, destination information of the vehicle and the traffic information may be stored in the memory 1300. The generated map data may also be stored in the memory (S340).

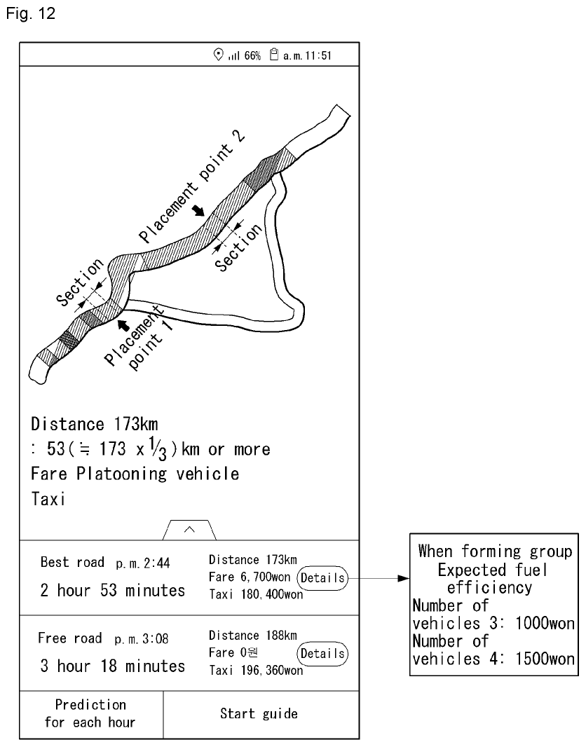

FIG. 12 is a diagram illustrating placement points and sections in map data according to an embodiment of the present disclosure.

Referring to FIG. 12, the map data may include at least any one of a source or the breakaway point of a group vehicle or a specific vehicle joining within a group, and may be configured based on any one of density, the number of lanes or improvement information.

The placement point may mean the place where vehicles to perform platooning are rearranged as a formation of a specific group vehicle or group vehicles that travel. Therefore, a vehicle that will perform platooning may be specified or a criterion may be selected based on the place suitable for the purpose of a formation rearrangement.

The placement point may be set at each of distances divided into three equal parts based on the driving path of a vehicle that travels the longest distance among a plurality of vehicles based on obtained destination information. Furthermore, the placement point may include a start point where a V2X message is received from each of a plurality of vehicles. The placement point may include at least any one of the breakaway point of a group vehicle or a specific vehicle joining a group.

According to an embodiment of the present disclosure, a plurality of vehicles having different destinations has the purpose of equally improving fuel efficiency through platooning. Accordingly, the number of vehicles capable of improving fuel efficiency by forming a group may be set. According to an embodiment of the present disclosure, the number of vehicles may be set to a maximum of 4.

If four vehicles travel as a group, at least three placement points may be formed because three vehicles except a vehicle having the longest traveling distance may break away from the group. Furthermore, if a specific vehicle that will join the group is found, another placement point may be added.

According to an embodiment of the present disclosure, while a total of four vehicles, such as two vehicles A having the same model and a vehicle B and vehicle C having different models, perform platooning, if a vehicle A having the same model and traveling along the same path as that of the platooning at the point where roads are jointed is present nearby, the point may be set as a placement point in order to break any one of the vehicles B and C from the group and join the vehicle A into the group.

When a placement point is selected, a preset critical section may be determined based on any one of the density of roads or the number of lanes.

At least one preset critical section in which the density of vehicles is small or the number of lanes is many may be selected as the preset critical section so that a vehicle can be easily placed based on traffic information obtained through the data communication unit 1100.

Specifically, a portion indicated by an oblique line in the map data may correspond to a yellow section in navigation. A portion indicated by a dual oblique line may correspond to a red section in the navigation. A portion having no indication may correspond to a green section in the navigation.

A placement point 1 is the place where the density of vehicles is high, in which the distance between stop areas indicated by an oblique line is narrow. Accordingly, in the placement point 1, a preset critical section for placement may be shortly represented because the interval between vehicles is narrow.

In contrast, a placement point 2 is the place where the density of vehicles is low, in which the distance between stop areas indicated by an oblique line is wide. Accordingly, in the placement point 2, a preset critical section for placement may be represented relatively long because the interval between vehicles is wide.

According to an embodiment of the present disclosure, if the number of vehicles is set to 4 and the density of vehicles is low or the number of lanes is small, a critical section may be set long because the distance between a plurality of vehicles is long.

Furthermore, if the density of vehicles is high or the number of lanes is many although the number of vehicles is set to 4, a critical section may be set shortly because the distance between a plurality of vehicles is close.

A vehicle that performs platooning corresponding to ⅓ or more of a path having the longest distance, among first group vehicles, in at least one of a source or the breakaway point of a group vehicle or the joining point of a specific vehicle within the group may be set as a second group vehicle.

Specifically, referring to FIG. 12, in the case of platooning in which a distance from a source to a destination is a total of 173 km, a vehicle that travels 53 km or more together may be set as a second group vehicle.

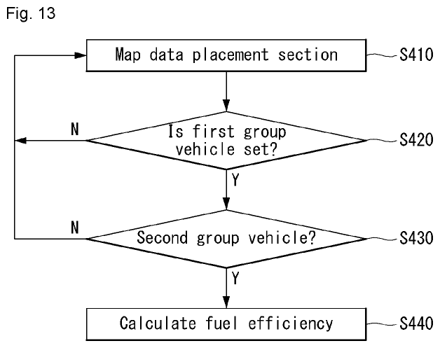

FIG. 13 is a flowchart illustrating a process of selecting a group vehicle formation according to an embodiment of the present disclosure.

Referring to FIG. 13, a placement section in which a group formation will be changed may be selected from placement points formed in the map data generated in FIG. 12 (S410).

Referring to FIG. 12, any one of the placement point 1 or 2 may be selected. After the group formation is changed at the placement point 1, if a new vehicle joins a lane through a forked road and joins the group, the placement point 2 may be changed.

A vehicle included in a preset critical section based on the placement point of a plurality of vehicles indicated in the map data may be set as a first group vehicle (S420).

The preset critical section may mean that it is determined based on any one of the density of vehicles, the number of lanes or the number of vehicles indicated in the map data.

Specifically, at least one preset critical section in which the density of vehicles is low or the number of lanes is many may be selected as the preset critical section so that a vehicle can be easily placed based on traffic information obtained through the data communication unit 1100.

According to an embodiment of the present disclosure, if the number of vehicles is set to 4 and the density of vehicles is low or the number of lanes is small, a critical section may be set long because the distance between a plurality of vehicles is long.

Furthermore, if the density of vehicles is high or the number of lanes is many although the number of vehicles is set to 4, a critical section may be set shortly because the distance between a plurality of vehicles is close.

A vehicle included in the preset critical section is set as a first group vehicle. Destination information may be received through a V2X message from each of a plurality of the first group vehicles.

The moving distance of a second group may be configured with vehicles whose moving distance is ⅓ or more based on a vehicle having the longest destination among at least first group vehicle.

The moving distance of the first group may be determined based on a vehicle having the longest destination among the first group vehicles.

The moving distance of the second group may be configured with vehicles whose moving distance is ⅓ or more based on a vehicle having the longest destination, among at least first group vehicles (S430).

In order to change the group formation of the determined second secondary group vehicle, fuel efficiency improvement information may be calculated (S440).

The fuel efficiency improvement information may be calculated based on a difference between fuel efficiency information and actually consumed fuel of a plurality of vehicles.

The actually consumed fuel may mean fuel consumed to travel a preset critical distance based on the map data.

According to an embodiment of the present disclosure, the preset critical distance may be set by dividing a distance from a source to a destination at given intervals based on a vehicle that travels to the longest destination among the second group vehicles.

Furthermore, the preset critical distance may include a placement point. Actually consumed fuel of a vehicle that has the greatest fuel efficiency improvement amount consumed for the travelling of the second group vehicle and that has reduced a given amount may be measured.

The following shows an example in which actually consumed fuel is measured based on a fuel efficiency improvement amount in a preset critical distance.

According to an embodiment of the present disclosure, in relation to the fuel efficiency improvement information, it may be assumed that if a vehicle A and a vehicle B travel on a highway having a straight line of 20 km or more and a gas price announced in a government site is 1500 won per litre (L), fuel efficiency of the vehicle A is 15 km/L (100 won per km) and fuel efficiency of the vehicle B is 30 km/L (50 won per km).

Assuming that the vehicles travel the same distance of 10 km or more, that is, a placement section, if the vehicles A and B form a group and travel in order of the vehicle A-vehicle B, fuel efficiency of each of the vehicles A and B may be calculated in a 1 km unit as follows. If fuel efficiency of the vehicle A is 15 km/L without any change and fuel efficiency of the vehicle B becomes 50 km/L (30 won per km) because the vehicle B follows the vehicle A, the vehicle B has reduced 20 won per km at an amount. Accordingly, the vehicle B can reduce 20 won per km.

If the driving sequence is changed whenever a fuel efficiency interval between the two vehicles is improved based on 100 won, when the vehicles A and travel 5 km, fuel efficiency of the vehicle A is 0 won and fuel efficiency of the vehicle B is −100 won. Accordingly, in this case, the sequence of the two vehicles may be changed.

According to an embodiment of the present disclosure, in the fuel efficiency improvement information, assuming that the vehicles A and B form a group and travel in order of the vehicle B-vehicle A, if fuel efficiency of the vehicle B is 30 km/L and fuel efficiency of the vehicle A is 20 km/L (75 won per km) because the vehicle A follows the vehicle B. Accordingly, the vehicle A can reduce 25 won per km. If the vehicles A and B travel the same distance of 4 km, fuel efficiency of the vehicles A and B equally become −100 won. Accordingly, the sequence of the vehicles A and B may not be changed. Thereafter, if the vehicles A and B further travel the same distance of 4 km, fuel efficiency of the vehicle B becomes −100 won and fuel efficiency of the vehicle A becomes −200 won. Accordingly, the driving sequence may be changed because a difference between the pieces of fuel efficiency is 100 won or more.

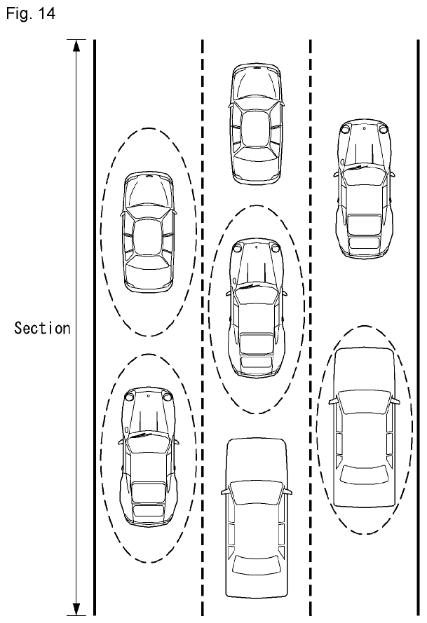

FIG. 14 is a diagram illustrating a specified group indicated in map data according to an embodiment of the present disclosure.

Referring to FIG. 14, a preset critical section may be indicated. A vehicle included in a placement point may be indicated as a first group vehicle (e.g., 7 vehicles in FIG. 14). In this case, a vehicle that performs platooning of ⅓ based on a vehicle having the longest destination may be indicated as a second group vehicle (e.g., 4 vehicles indicated by dotted lines) (S430).

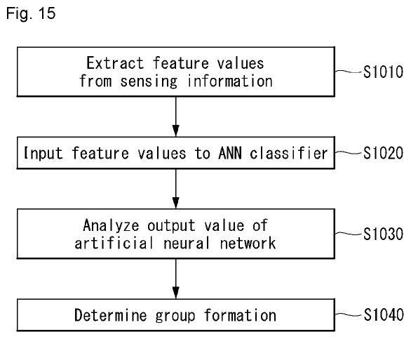

FIG. 15 is a diagram for describing an example in which a group is determined according to an embodiment of the present disclosure.

Referring to FIG. 15, the processor 1400 may extract feature values from sensing information obtained through at least one sensor in order to determine a formation of a group (S1010).

For example, the processor 1400 may receive destination information of a vehicle from at least one sensor (e.g., vision sensor). The processor 1400 may extract a feature value from the destination information of the vehicle. The feature value may specifically indicate a group formation based on average fuel efficiency improvement information of a group vehicle among at least one feature which may be extracted from sensing information of the group vehicle.

The processor 1400 may control the feature values to be input to an artificial neural network (ANN) classifier trained to identify whether a plurality of group vehicles consumes the same fuel efficiency (S1020).

The processor 1400 may generate a group determination input by combining the extracted feature values. The group determination input may be input to an artificial neural network (ANN) classifier trained to select a group formation based on average fuel efficiency improvement information of group vehicles based on the extracted feature value.

The processor 1400 may analyze an output value of the artificial neural network (S1030), and may determine a formation of the group based on the artificial neural network output value (S1040).

The processor 1400 may identify whether to change or maintain the group formation based on the output value of the artificial neural network classifier.

In FIG. 15, an example in which an operation of determining a group formation through AI processing has been implemented in the processing of the vehicle 10 has been described, but the present disclosure is not limited thereto. For example, the AI processing may be performed over a 5G network based on sensing information received from the vehicle 10.

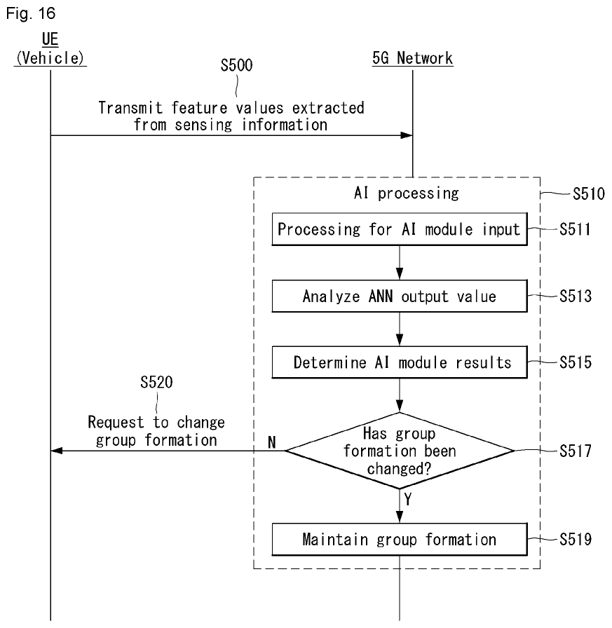

FIG. 16 is a flowchart illustrating an example of a process of transmitting and receiving, by a vehicle and the control apparatus, information according to an embodiment of the present disclosure.

The processor 1400 may control the communication unit to transmit determination information of a group formation to an AI processor included in a 5G network. Furthermore, the processor 1400 may control the communication unit to receive AI-processed information from the AI processor.

The AI-processed information may be information on which any one of the change or maintenance of the group formation is determined.

The vehicle 10 may perform an initial access procedure with the 5G network in order to transmit the determination information of the group formation to the 5G network. The vehicle 10 may perform the initial access procedure with the 5G network based on a synchronization signal block (SSB).

Furthermore, the vehicle 10 may receive, from the 5G network, downlink control information (DCI) used to schedule the transmission of determination information of the group formation obtained from at least one sensor provided within the vehicle through the radio communication unit.

The processor 1400 may transmit the determination information of the group formation to the network based on the DCI.

The determination information of the group formation is transmitted to the 5G network through a PUSCH. The SSB and the DM-RS of the PUSCH may be QCLed with respect to a QCL type D.

Referring to FIG. 16, the vehicle 10 may transmit, to a 5G network, a feature value extracted from sensing information (S500).

In this case, the 5G network may include an AI processor or an AI system. The AI system of the 5G network may perform AI processing based on the received sensing information (S510).

The AI system may input, to an ANN classifier, the feature values received from the vehicle 10 (S511). The AI system may analyze an ANN output value (S513), and may determine the state of a driver based on the ANN output value (S515). The 5G network may transmit, to the vehicle 10, determination information of a group formation determined by the AI system through the radio communication unit.

In this case, the determination information of the group formation may include information indicating whether to maintain or change the group formation.

If it is determined to change the group formation (S517), the AI system may change the driving formation of a plurality of the vehicles.

If the group formation is changed, the AI system may determine whether to remotely control the change of the group formation. Furthermore, the AI system may transmit, to the vehicle 10, information (or signal) related to the remote control.

The vehicle 10 transmits only the sensing information to the 5G network, and may extract, from the sensing information, a feature value corresponding to a group determination input to be used as the input of an artificial neural network for determining a group formation within the AI system included in the 5G network.

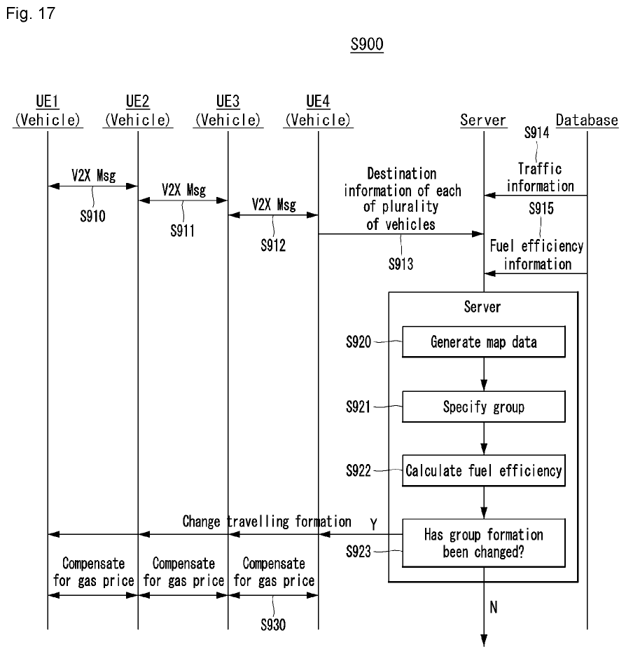

FIG. 17 is a diagram for specifically describing a flow of data between elements according to an embodiment of the present disclosure.

A method of controlling a plurality of vehicles performing platooning in the autonomous driving system is described with reference to FIG. 17.

In order to generate map data, sensing information obtained through sensors of a plurality of vehicles may be mapped to a map (S910, S911, and S912). Destination information of the vehicles obtained from the V2X messages of the plurality of vehicles may be mapped to the map (S913). Traffic information obtained from a server may be mapped to the map (S915 and S920).

The step of specify a group based on the map data may include selecting the placement point of each vehicle based on the destinations and density of the vehicles and the number of lanes, setting, as a first group vehicle, a vehicle included in a preset critical section, and determining, as a second group vehicle, a vehicle that performs platooning of ⅓ or more based on a vehicle having the longest destination (S921).

The step of partitioning a placement point may further include a section using the place where the density of vehicles is low and a lane is wide as a starting point.

Fuel efficiency improvement information of each of the plurality of vehicles that perform platooning may be calculated based on a difference between the fuel efficiency information and actually consumed fuel of the plurality of vehicles (S915 and S922).

The actually consumed fuel may be calculated based on fuel consumed to travel a unit section set based on the map data.

A group formation of the plurality of vehicles that performs platooning may be changed based on the fuel efficiency improvement information so that the plurality of vehicles has the same fuel efficiency improvement information (S923).

In the group formation, a vehicle having greater fuel efficiency improvement information may be set as a vehicle having higher fuel efficiency ranking. A vehicle having higher fuel efficiency ranking may be moved to lower ranking (S930).

The group formation may be selected based on the number of platooning vehicles and a geographical feature, and may provide passenger services based on the results of an AI model. Furthermore, the group formation may be processed based on one fuel efficiency ranking if fuel efficiency improvement information is the same.

The group formation may include a case where a vehicle joins or leaves a group.

If a vehicle joins a group, an average of fuel efficiency improvement information before the vehicle joins the group may be calculated.

If a vehicle leaves a group, whether an expected driving path of the vehicle is different from the driving path of the group may be determined. A fuel efficiency compensation may be performed based on a difference between average values of the fuel efficiency improvement information.

If the group formation is not changed, the vehicles may travel while maintaining the group formation (S930).

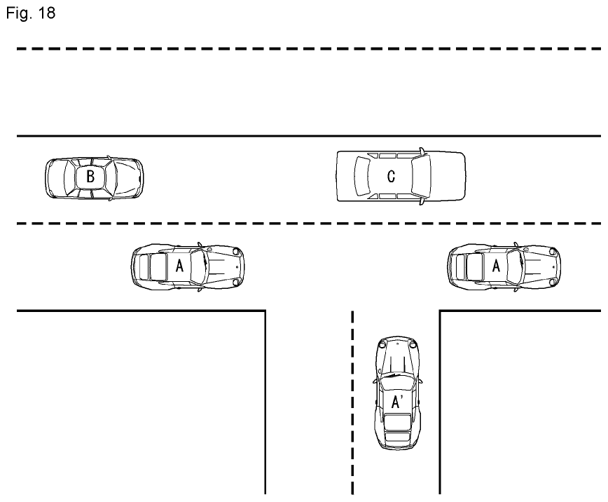

FIG. 18 is a diagram illustrating control of a group formation according to an embodiment of the present disclosure.

Referring to FIG. 18, at least one vehicle within a group may be controlled to leave the group. A specific vehicle selected based on at least any one of a model or destination information of the vehicle included in the group may join the group.

Specifically, in FIG. 18, while a total of four vehicles, such as two vehicles A having the same mode and a vehicle B and vehicle C having different models, form a group and perform platooning, if a vehicle A′ having the same model as the vehicle A traveling along the same path as the platooning is present near a point at which roads are met, the control apparatus may configure a group formation by controlling any one of the vehicle B and vehicle C having different models to be left and the vehicle A′ to join the group.

Fuel efficiency improvement efficiency of each of a plurality of vehicles is greatly influenced by its model. If vehicles have the same model, there is an effect in that the entire fuel efficiency of vehicles performing platooning can be improved by reducing the number of times that the sequence of the platooning is changed. Accordingly, if a driving path to a destination is the same, it may be advantageous to form vehicles having the same model as a specific group.

Embodiments applied in the present disclosure are described below.

According to a first embodiment of the present disclosure, a method of controlling a plurality of vehicles performing platooning in an autonomous driving system includes generating map data in order to form a group of a plurality of vehicles, specifying a group based on the map data, obtaining fuel efficiency information of the plurality of vehicles performing the platooning, calculating fuel efficiency improvement information according to the platooning based on the fuel efficiency information, and controlling a group formation when a difference between the fuel efficiency improvement information of a first vehicle having a minimum fuel efficiency improvement and the fuel efficiency improvement information of a second vehicle having a maximum fuel efficiency improvement among the plurality of vehicles exceeds a preset critical range.

Second embodiment: in the first embodiment, generating the map data may include mapping, to a map, at least one of sensing information obtained through sensors of the plurality of vehicles, destination information of the plurality of vehicles obtained through V2X messages or traffic information obtained through a server.

Third embodiment: in the first embodiment, specifying a group based on the map data may include setting a placement point of the vehicle based on any one of destinations of the vehicles, density of the vehicles, the number of lanes or the fuel efficiency improvement information, setting, as a first group vehicle, a vehicle included in a preset critical section based on the placement point, determining a moving distance within the group, and determining a second group vehicle based on the moving distance.

Fourth embodiment: in the third embodiment, the placement point may include at least any one of a source, a breakaway point of the second group vehicle or a point at which a specific vehicle joins the group. The placement point may be set based on any one of the density, the number of lanes or the fuel efficiency improvement information.

Fifth embodiment: in the first embodiment, the fuel efficiency improvement information may be calculated based on a difference between the fuel efficiency information and actually consumed fuel of the plurality of vehicles.

Sixth embodiment: in the fifth embodiment, the actually consumed fuel may be fuel consumed to travel a preset critical distance based on the map data.

Seventh embodiment: in the first embodiment, controlling a group formation may include setting a vehicle having higher fuel efficiency improvement information as a vehicle having higher fuel efficiency ranking and moving driving ranking of the vehicle having higher fuel efficiency ranking to lower ranking within the group.

Eighth embodiment: in the first embodiment, the group formation may be determined based on at least any one of the number of vehicles performing the platooning, type of the vehicles, destinations of the vehicles or geographical features.

Ninth embodiment: in the first embodiment, the group formation may be determined based on AI processing results.

Tenth embodiment: in the seventh embodiment, controlling a group formation may include considering, as identical fuel efficiency ranking, vehicles having identical fuel efficiency improvement information.

Eleventh embodiment: in the first embodiment, controlling a group formation may include updating the fuel efficiency improvement information within the group when a joining vehicle or a breakaway vehicle occurs.

Twelfth embodiment: in the first embodiment, controlling a group formation may include controlling at least one vehicle performing the platooning to leave the group and controlling a specific vehicle selected based on at least any one of a model or destination information of a vehicle performing the platooning to join the group.

Thirteenth embodiment: in the eleventh embodiment, the method may further include measuring an average of the fuel efficiency improvement information of a specific vehicle before the specific vehicle joins the group when the specific vehicle joins the group.

Fourteenth embodiment: in the eleventh embodiment, controlling a group formation may include detecting, as a breakaway vehicle, a vehicle whose path different from a driving path of the platooning vehicle may be set during the platooning and performing fuel efficiency calculation for all vehicles included in the group including the breakaway vehicle based on a difference between the fuel efficiency improvement information according to the platooning and fuel efficiency improvement information of the breakaway vehicle.

Fifteenth embodiment: in the eleventh embodiment, the method may further include performing fuel efficiency calculation based on a difference between a fuel efficiency improvement average value of the group calculated based on the fuel efficiency improvement information of the plurality of vehicles and a fuel efficiency improvement value of each of the plurality of vehicles when a specific vehicle leaves the group.

According to the sixteenth embodiment of the present disclosure, an apparatus for controlling a plurality of vehicles performing platooning in an autonomous driving system includes a communication unit, a memory, and a processor functionally connected to the communication unit and the memory. The communication unit receives fuel efficiency of the plurality of vehicles performing the platooning. The processor is configured to generate map data for forming a group of the plurality of vehicles, store the map data in the memory, specify a group based on the map data, obtain fuel efficiency information of each of the plurality of vehicles through the communication unit, calculate fuel efficiency improvement information according to the platooning based on the fuel efficiency information, and control a group formation when a difference between the fuel efficiency improvement information of a first vehicle having a minimum fuel efficiency improvement and the fuel efficiency improvement information of a second vehicle having a maximum fuel efficiency improvement among the plurality of vehicles exceeds a preset critical range.

Seventeenth embodiment: in the sixteenth embodiment, information for forming the map data may include at least one of sensing information obtained through sensors of the plurality of vehicles, destination information of the plurality of vehicles obtained through V2X messages or traffic information obtained through a server.

Eighteenth embodiment: in the sixteenth embodiment, the processor includes a processor configured to specify a group by setting a placement point of the vehicle based on any one of destinations of the vehicles, density of the vehicles, the number of lanes or the fuel efficiency improvement information, setting, as a first group vehicle, a vehicle included in a preset critical section based on the placement point, determining a moving distance within the group, and determining a second group vehicle based on the moving distance.

Nineteenth embodiment: in the sixteenth embodiment, the placement point includes at least any one of a source, a breakaway point of the second group vehicle or a point at which a specific vehicle joins the group. The placement point is set based on any one of the density, the number of lanes or the fuel efficiency improvement information.

Twentieth embodiment: in the sixteenth embodiment, the processor includes a processor configured to calculate the fuel efficiency improvement information based on a difference between the fuel efficiency information and actually consumed fuel of the plurality of vehicles.

Twenty-first embodiment: in the twentieth embodiment, the actually consumed fuel is fuel consumed to travel a preset critical distance based on the map data.

Twenty-second embodiment: in the sixteenth embodiment, the processor includes a processor configured to control a group formation by setting a vehicle having higher fuel efficiency improvement information as a vehicle having higher fuel efficiency ranking and moving driving ranking of the vehicle having higher fuel efficiency ranking to lower ranking within the group.

Twenty-third embodiment: in the sixteenth embodiment, the processor includes a processor configured to select a group formation based on at least any one of the number of vehicles performing the platooning, type of the vehicles, destinations of the vehicles or geographical features.

Twenty-fourth embodiment: in the sixteenth embodiment, the processor includes a processor configured to control a group formation based on AI processing results.

Twenty-fifth embodiment: in the twenty-second embodiment, the processor includes a processor configured to consider, as one fuel efficiency ranking, vehicles having identical fuel efficiency improvement information.

Twenty-sixth embodiment: in the sixteenth embodiment, the processor includes a processor configured to control a group formation by updating the fuel efficiency improvement information within the group when a joining vehicle or a breakaway vehicle occurs.

Twenty-seventh embodiment: in the sixteenth embodiment, the processor includes a processor configured to control a group formation so that at least one vehicle performing the platooning leaves the group and a specific vehicle selected based on at least any one of a model or destination information of a vehicle performing the platooning joins the group.

Twenty-eighth embodiment: in the twenty-sixth embodiment, the processor includes a processor configured to measure an average of the fuel efficiency improvement information of a specific vehicle before the specific vehicle joins the group when the specific vehicle joins the group.

Twenty-ninth embodiment: in the twenty-sixth embodiment, the processor includes a processor configured to detect, as a breakaway vehicle, a vehicle whose path different from a driving path of the platooning vehicle is set during the platooning and perform fuel efficiency calculation for all vehicles included in the group including the breakaway vehicle based on a difference between the fuel efficiency improvement information according to the platooning and fuel efficiency improvement information of the breakaway vehicle.

Thirtieth embodiment: in the twenty-sixth embodiment, the processor includes a processor configured to perform fuel efficiency calculation based on a difference between a fuel efficiency improvement average value of the group calculated based on the fuel efficiency improvement information of the plurality of vehicles and a fuel efficiency improvement value of each of the plurality of vehicles when a specific vehicle leaves the group.

The present disclosure may be implemented in a medium in which a program has been written in the form of computer-readable code. The computer-readable medium includes all types of recording devices in which data readable by a computer system is stored. Examples of the computer-readable medium may include a hard disk drive (HDD), a solid state disk (SSD), a silicon disk drive (SDD), a ROM, a RAM, a CD-ROM, a magnetic tape, a floppy disk, and an optical data storage. Furthermore, the computer-readable recording includes an implementation having a form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

What is claimed is:

1. A method of controlling a plurality of vehicles performing platooning in an autonomous driving system, the method comprising:
generating map data in order to form a group of a plurality of vehicles;
specifying a group based on the map data;
obtaining fuel efficiency information of the plurality of vehicles performing the platooning;
calculating fuel efficiency improvement information according to the platooning based on the fuel efficiency information; and
controlling a group formation when a difference between the fuel efficiency improvement information of a first vehicle having a minimum fuel efficiency improvement and the fuel efficiency improvement information of a second vehicle having a maximum fuel efficiency improvement among the plurality of vehicles exceeds a preset critical range.

2. The method of claim 1,
wherein generating the map data includes mapping, to a map, at least one of sensing information obtained through sensors of the plurality of vehicles, destination information of the plurality of vehicles obtained through V2X messages or traffic information obtained through a server.

3. The method of claim 1,
wherein specifying a group based on the map data includes:
setting a placement point of the vehicle based on any one of destinations of the vehicles, density of the vehicles, a number of lanes or the fuel efficiency improvement information;
setting, as a first group vehicle, a vehicle included in a preset critical section based on the placement point;
determining a moving distance within the group; and
determining a second group vehicle based on the moving distance.

4. The method of claim 3,
wherein the placement point includes at least any one of a source, a breakaway point of the second group vehicle or a point at which a specific vehicle joins the group, and
wherein the placement point is set based on any one of the density, the number of lanes or the fuel efficiency improvement information.

5. The method of claim 1,
wherein the fuel efficiency improvement information is calculated based on a difference between the fuel efficiency information and actually consumed fuel of the plurality of vehicles.

6. The method of claim 5,
wherein the actually consumed fuel is fuel consumed to travel a preset critical distance based on the map data.

7. The method of claim 1,
wherein controlling a group formation includes:
setting a vehicle having higher fuel efficiency improvement information as a vehicle having higher fuel efficiency ranking; and
moving driving ranking of the vehicle having higher fuel efficiency ranking to lower ranking within the group.

8. The method of claim 1,
wherein the group formation is determined based on at least any one of a number of vehicles performing the platooning, type of the vehicles, destinations of the vehicles or geographical features.

9. The method of claim 1,
wherein the group formation is determined based on AI processing results.

10. The method of claim 7,
wherein controlling a group formation includes considering, as identical fuel efficiency ranking, vehicles having identical fuel efficiency improvement information.

11. The method of claim 1,
wherein controlling a group formation includes updating the fuel efficiency improvement information within the group when a joining vehicle or a breakaway vehicle occurs.

12. The method of claim 1,
wherein controlling a group formation includes:
controlling at least one vehicle performing the platooning to leave the group; and
controlling a specific vehicle selected based on at least any one of a model or destination information of a vehicle performing the platooning to join the group.

13. The method of claim 11, further including measuring an average of the fuel efficiency improvement information of a specific vehicle before the specific vehicle joins the group when the specific vehicle joins the group.

14. The method of claim 11,
wherein controlling a group formation includes:
detecting, as a breakaway vehicle, a vehicle whose path different from a driving path of the platooning vehicle is set during the platooning; and
performing fuel efficiency calculation for all vehicles included in the group including the breakaway vehicle based on a difference between the fuel efficiency improvement information according to the platooning and fuel efficiency improvement information of the breakaway vehicle.

15. The method of claim 11, further including performing fuel efficiency calculation based on a difference between a fuel efficiency improvement average value of the group calculated based on the fuel efficiency improvement information of the plurality of vehicles and a fuel efficiency improvement value of each of the plurality of vehicles when a specific vehicle leaves the group.

16. An apparatus for controlling a plurality of vehicles performing platooning in an autonomous driving system, the apparatus comprising:
a communication unit;
a memory; and
a processor functionally connected to the communication unit and the memory,
wherein the communication unit receives fuel efficiency of the plurality of vehicles performing the platooning, and
wherein the processor is configured to:
generate map data for forming a group of the plurality of vehicles,
store the map data in the memory,
specify a group based on the map data,
obtain fuel efficiency information of each of the plurality of vehicles through the communication unit,
calculate fuel efficiency improvement information according to the platooning based on the fuel efficiency information, and
control a group formation when a difference between the fuel efficiency improvement information of a first vehicle having a minimum fuel efficiency improvement and the fuel efficiency improvement information of a second vehicle having a maximum fuel efficiency improvement among the plurality of vehicles exceeds a preset critical range.

17. The apparatus of claim 16,
wherein information for forming the map data includes at least one of sensing information obtained through sensors of the plurality of vehicles, destination information of the plurality of vehicles obtained through V2X messages or traffic information obtained through a server.

18. The apparatus of claim 16,
wherein the processor is configured to set a placement point of the vehicle based on any one of destinations of the vehicles, density of the vehicles, a number of lanes or the fuel efficiency improvement information.

19. The apparatus of claim 16,
wherein the fuel efficiency improvement information is calculated based on a difference between the fuel efficiency information and actually consumed fuel of the plurality of vehicles.

20. The apparatus of claim 16,
wherein the processor is configured to update the fuel efficiency improvement information within the group when a joining vehicle or a breakaway vehicle occurs.
